(19) United States
(12) Patent Application Publication
(10) Pub. No.: US 2020/0034025 A1
(43) Pub. Date: Jan. 30, 2020

(54) SYSTEMS AND METHODS FOR MULTISENSORY SEMIOTIC COMMUNICATIONS

(71) Applicants: Lois Jean Brady, Martinez, CA (US); Matthew Guggemos, Napa, CA (US)

(72) Inventors: Lois Jean Brady, Martinez, CA (US); Matthew Guggemos, Napa, CA (US)

(21) Appl. No.: 16/046,565

(22) Filed: Jul. 26, 2018

(51) Int. Cl. G06F 3/0484; G06T 13/40; G06F 3/0482; G06F 3/0481; G06F 3/0488; G06T 13/20; G06F 3/16; G10L 15/197; G09B 19/00

(52) U.S. Cl. CPC G06F 3/04845; G06T 13/40; G06F 3/0482; G06F 3/04817; G09B 19/00; G06T 13/205; G06F 3/167; G10L 15/197; G06F 3/0488

(57) ABSTRACT

The present disclosure relates generally to systems and methods for receiving visual and communication inputs, and generating, modifying, and outputting multisensory semiotic communications. The multisensory semiotic communications can include an avatar, a dynamic image, an expressed phrase, and a visual text. The multisensory semiotic communications can be modified based on one or more customization selections. The customization selections can include a gender selection, an age selection, an emotion selection, a race selection, a location selection, a nationality selection, and a language selection.

### TECHNICAL FIELD

The present disclosure relates generally to systems and methods for receiving visual and communication inputs, generating multisensory semiotic tools, and outputting the multisensory semiotic tools, wherein the multisensory semiotic tools comprise an avatar, a dynamic image, an expressed phrase, and visual text.

### BACKGROUND

Current communication systems lack the ability to convey emotions and do not combine multiple communication techniques. Current educational tools may teach words through illustrating an image associated with the word, but, they do not model the user to allow the user to not only teach the desired word or phrase but to also illustrate the emotion to present when speaking the word or phrase. Underdeveloped children, especially autistic children, learn better through video-self modeling which has never been done before. Children with autism have difficulty understanding facial expressions, recognizing familiar faces and mimicking social-communicative behavior which is not solved by current educational techniques. There are a range of tools available to help individuals overcome their communication barriers including the use of pictures, gestures, sign, language, visual aids, or speech-output devices. Current educational techniques may present images, words, and an avatar for the user separately, but there is no single tool which combines words or phrases, images associated with the words or phrases, and an avatar conveying emotions generated from the user.

### SUMMARY

This section provides a general summary of the present disclosure and is not a comprehensive disclosure of its full scope or all of its features, aspects, and objectives.

Disclosed herein are aspects of implementations of systems and methods for multisensory semiotic communications. In one example, a system can receive a first input and a second input, generate an avatar based on the first input, and generate a dynamic image based on the second input.

Also disclosed herein is an example method of receiving visual and communication inputs and generating an avatar, a dynamic image, an expressed phrase, and a visual text. The avatar, dynamic image, expressed phrase, and visual text can be modified based on a received customization selection. The customization selection can comprise at least one of a gender selection, an age selection, an emotion selection, a race selection, a location selection, a nationality selection, and a language selection. The avatar, dynamic image, expressed phrase, and visual text, which comprise the multisensory semiotic communications, can be output to a display.

Also disclosed herein is an example method of receiving and linking at least two customization selections together. Linking the two or more customization selections together can provide better and more user-preferred modifications of the avatar, dynamic image, expressed phrase, or visual text.

Also disclosed herein is an example method of receiving at least one of the customization selections, generating a button or an emoticon based on the customization selection, and then outputting the button or emoticon to a display. Selecting the button or emoticon that is based on the customization selection can modify the avatar, dynamic image, expressed phrase, or visual text.

Further disclosed herein are example implementations of systems that are capable of performing the methods disclosed herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram illustrating an example of a system for multisensory semiotic communications.

FIG. 2 illustrates an example of the multisensory semiotic communications on a display.

FIG. 3 is an example method of generating, outputting, storing, and sharing multisensory semiotic communications.

FIG. 4 is an example method of generating, modifying, and outputting, multisensory semiotic communications.

FIG. 5 is a continuation of the method in FIG. 4 illustrating the steps of outputting a customization list and receiving a customization selection.

FIG. 6 is an example method of receiving at least two customization selections, linking the two or more customization selections together to create a linked input, and saving the linked input.

FIG. 7 is an example method of receiving a customization selection, generating a button based on the customization selection, and outputting the button to a display.

FIG. 8 is an example method of modifying features on an avatar based on touch inputs.

FIGS. 9A-D are example illustrations of the method of FIG. 8.

FIG. 10 illustrate an example setup of the multisensory semiotic communications layout on the display.

FIGS. 11A and B illustrate an example setup of the multisensory semiotic communications layout on the display.

FIG. 12 illustrates an example setup of the multisensory semiotic communications layout on the display.

FIGS. 13A-D illustrate an example setup of the multisensory semiotic communications.

### DETAILED DESCRIPTION

Multisensory semiotic communications allow for learning through engagement. For example, a user is able to view an avatar generated based on mirror activity. Mirror activity is the ability for a user to engage with themselves. Engagement through mirror activity can enhance learning as well as speech development. Users can use multisensory semiotic communications to create avatars based on themselves and modify the avatars with emotions so that the users can better understand how to act by learning through familiarity. Allowing the avatar to convey emotions, through tone of voice, facial or body expressions, has far-reaching benefits for enhancing communication skills for any individual. Further, by generating an avatar with emotion and combining the avatar with spoken, written, or gestured symbols with meaning, the multisensory semiotic communications help users become more effective communicators, support their own decision-making and allow them to become more independent: overall improving social communication and helping to improve the quality of life of all users.

The following description is merely exemplary in nature and is not intended to limit the disclosure in its application or uses. For purposes of clarity, the same reference numbers are used in the description and drawings to identify similar elements.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

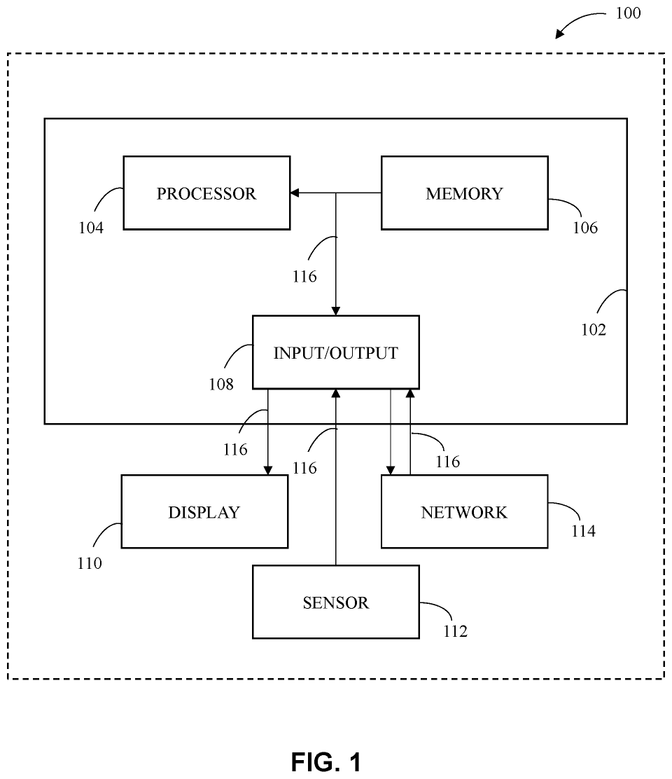

FIG. 1 is a block diagram illustrating an example of a multisensory semiotic communications system 100 in which the features and elements of the disclosed technology may be implemented. The multisensory semiotic communications system 100 can include a control module 102. The control module 102 can include a processor 104, a memory 106, and an input/output 108. The control module 102 can include components connected via a bus 116. The components can also be connected to a display 110, a sensory component such as sensory 112, and a network 114 via the bus 116

The processor 104 can execute one or more instructions including program instructions, which can be stored in a memory (e.g., the memory 106). The processor 104 can include one or more: central processing units (CPUs) with one or more cores; special purpose processors with one or more cores; digital signal processors (DSPs); microprocessors; controllers; microcontrollers; integrated circuits; Application Specific Integrated Circuits (ASIC); Field Programmable Gate Arrays (FPGA); or programmable logic controllers.

The memory 106 can include a tangible non-transitory computer-readable medium for storing program instructions including machine-readable instructions, computer-readable instructions, or any type of instructions which may be encoded as data and used by a processor (e.g., the processor 104). For example, the memory 106 can include any computer readable medium that may be accessed by the processor 104, including read only memory (ROM) or random access memory (RAM). Further, the memory 106 can include volatile memory (e.g., DRAM, SRAM) or non-volatile memory including: solid state drives (SSDs); hard disk drives (HDDs); non-volatile random access memory; or erasable programmable read-only memory (EPROM).

The bus 116 can include an internal bus or an external bus and may be used to couple components including the processor 104, the memory 106, the input/output 108, the display 110, and the sensor 112. The bus 116 can be used to transfer signals, including data, between the different components. For example, the bus 116 can include one or more buses including: a universal serial bus (USB); a peripheral component interconnect (PCI); PCI Express; a Serial AT attachment (SATA); or a HyperTransport (HT) bus.

The input/output 108 can be used to receive input (e.g., from an input device) or generate output (e.g., to an output device). Signals, including data relating to the inputs and outputs associated with the input/output 108 can be transmitted via the bus 116. The input/output 108 can receive input from input devices including, but not limited to, touchscreens, keyboards, computer mice, and microphones. The input/output 108 can generate output to output devices including, but not limited to, computer displays (e.g., LCD monitors), smartphones, tablets, and loudspeakers.

The sensor 112 can include any combination of hardware, software, or firmware, which is used to exchange (send or receive) signals (e.g., electronic signals) including communicating data (e.g., file data) either locally within the multisensory semiotic communications system 100 or to other devices. In one example implementation, the sensor 112 includes a communication interface (e.g., a network interface card) that can be configured to transmit or receive data from other devices.

The display 110 can comprise any device capable of displaying the data sent through the bus 116. The display 110 can comprise at least one of a mobile phone, a computer, an augmented reality device, a virtual reality device, a device capable of creating a holographic display, or any other desirable device. The display 110 may include a display screen located on a mobile phone, a computer, an augmented reality device, a virtual reality device, or any other desirable device. For example, the display 110 is not limited to a device with a physical screen and instead may be located on a virtual reality machine or a device capable of creating holographic displays.

The network 114 can comprise any internet or intranet server such as a public or private network. The network 114 may be used by the system 100 to communicate with other systems or devices. The system 100 can include additional and/or fewer components and is not limited to those illustrated in FIG. 1.

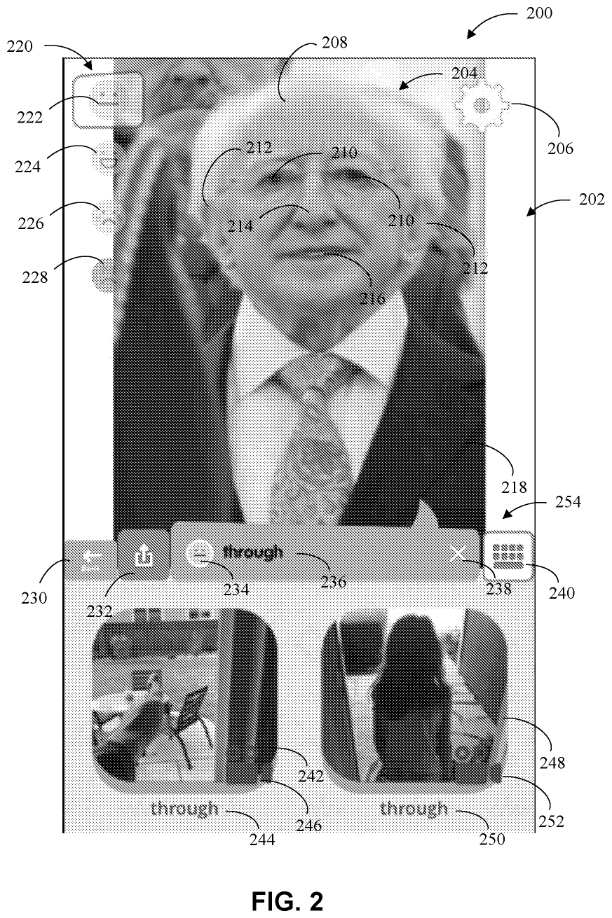

FIG. 2 illustrates one example of the multisensory semiotic communications system 100 on the display 110. The display 110 illustrates the multisensory semiotic communications system 100 by creating an animation area 202. The animation area 202 can allow the user or system 100 to place the multisensory semiotic communications where desired. The animation area 202 may have at least one of an avatar 204, a visual text 236, and a dynamic image 242, 248, or any other desirable feature. In this example embodiment, the avatar 204 can be located at the top of the animation area 202, the dynamic images 242, 248 can be located at the bottom of the animation area 202, and the visual text 236 can be located in the middle of the animation area 202 between the avatar 204 and the dynamic images 242, 248. The animation area also contains various setting features as well as generated buttons 220, described in more detail below.

The avatar 204 may be generated from any image and in this example embodiment the avatar 204 is a human male with a head 208 having eyes 210, ears 212, a nose 214, a mouth 216, and a body 218. The avatar 204 may have a number of other features and may be customized by the user or the system 100. The avatar 204 in this embodiment has a body 218. The animation area 202 can include an avatar 204 having a full body including arms and legs or may contain an avatar 204 having just a head. Each feature on the avatar 204, such as the eyes 210, the ears 212, the nose 214, the mouth 216, and the body 218, may be animated in order to move when communicating. The features can be animated at the same time or at separate times. For example, the mouth 216 may be animated (e.g., move or open and close) when the avatar 204 generates an expressed phrase as speech. The body 218 may be animated or move when the avatar 204 generates an expressed phrase as sign language. Other animation or movement may also take place. The expressed phrase can be generated based on the visual text 236. The expressed phrase can be speech, sign language, body language, any other animated speech, or any other desirable animation. For example, the expressed phrase can include an avatar 204 speaking a word or phrase, using his/her hands to sign a word or phrase, or can be movements of the body to illustrate the body language of the avatar 204.

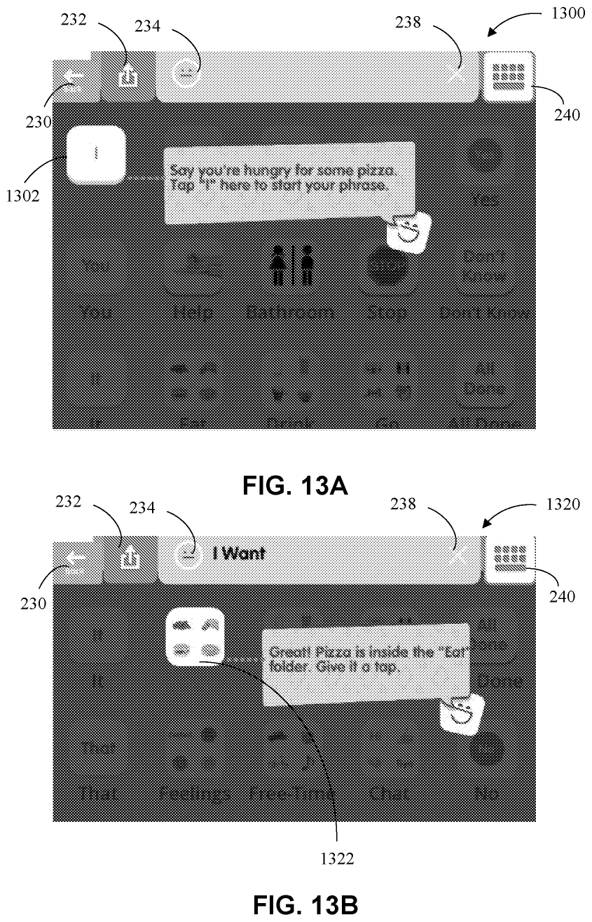

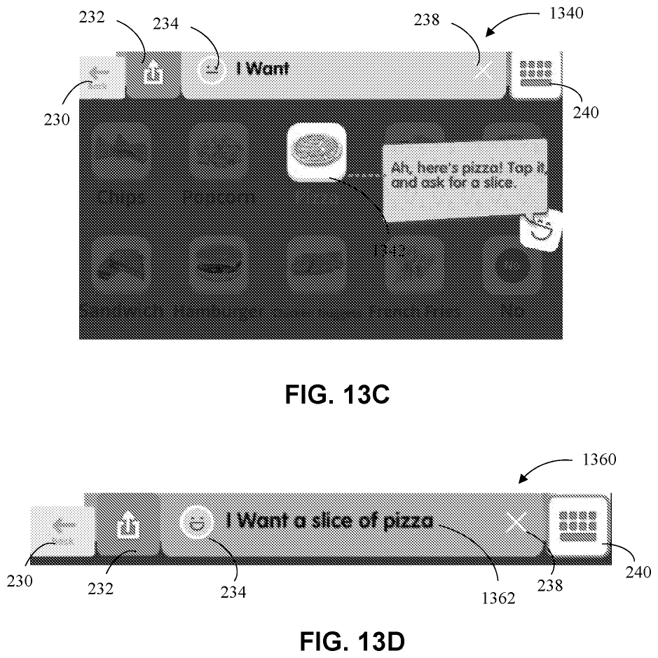

The example visual text 236 in FIG. 2 can be located at the center of a setting bar 254 which can be located between the avatar 204 and the dynamic images 242, 248. The visual text 236 includes the text “through.” The visual text 236 may be any phrase generated by the user or the system 100, or selected by the user or the system 100. The visual text 236 can be used to generate the expressed phrase. One example of the generation of the visual text 236 and the expressed phrase is shown in FIGS. 13A-D.

The dynamic images 242, 248 can be located at the bottom of the animation area 202. In this embodiment, there can be two dynamic images 242, 248, but, only one dynamic image may be shown on the display 110. Both dynamic images 242, 248 can be based on the same visual text 236. Multiple dynamic images may be generated based on multiple different visual texts. The dynamic images 242, 248 illustrate the title of the dynamic images 242, 248 with a text “through” 244, 250. The dynamic images 242, 248 show a moving image or a video based on the visual text 236. The dynamic images 242, 248 may be enlarged to cover the animation area 202 while the expressed phrase is expressed or after the expressed phrase is expressed. The dynamic image 242, 248 may also be a non-moving image if the object of the image can be understood without the use of movement. In this embodiment, the object of the dynamic images 242, 248 is “through.” In the first dynamic image 242, a person represents “through” by moving their hand “through” a door. In the second dynamic image 248, a young girl represents “through” by walking “through” a doorway.

The animation area 202 also contains various setting features located around the display 110. The display 110 has a settings button 206, a back button 230, an upload button 232, a reset button 238, a multisensory semiotic communications selection button 240, and a dynamic image selection button 246, 252. The back button 230, upload button 232, reset button 238, and multi sensory semiotic communications selection button 240 may be located on the setting bar 254. The settings button 206 contains a list of setting features that allow the user to customize the layout of the display 110, adjust volume levels, change users, change search engines for the dynamic images, or any of the like. The back button 230 can allow the user to exit out of the display 110 and either start over on the avatar generation screen or exit out of the application. The upload button 232 can allow the user to upload a file from his/her phone. The file may be an image to be used as an avatar or a dynamic image or may be saved speech that the user wants the avatar 204 to speak. The reset button 238 can allow the user to clear the visual text in order for the user to enter a new visual text generate a new visual text using the multi sensory semiotic communications selection button 240. The multisensory semiotic communications selection button 240 may be used to generate or select a number of multisensory semiotic communications. Button 240 may be used to generate a visual text, an expressed phrase, an avatar, and the dynamic image. Dynamic image selection buttons 246, 252 may be selected by the user to further generate or select dynamic images. These buttons can be distinct from the button 240 because these buttons 246, 252 allow the user to instantly enter the camera application on the user's device to begin recording a dynamic image to be used.

The display 110 also contains generated buttons 220. The generated buttons 220 in this embodiment are emoticons 220 based on an emotion selection input further described below. The emoticons 220 are buttons that allow the user to change the emotion of the multisensory semiotic communications. The emoticons 220 comprise a complacent button 222, happy button 224, sad button 226, and an angry button 228. The emoticons are not limited to the shown emotions and may include many more emotions. Current emotion selection 234 located next to the visual text 236 illustrates which emoticon is currently selected. In this embodiment, the complacent button 234 has been selected by the user. The generated buttons 220 may also comprise one or more gender buttons, age buttons, race buttons, location buttons, nationality buttons, and language buttons, all of which modify the multisensory semiotic communications corresponding to the button selection.

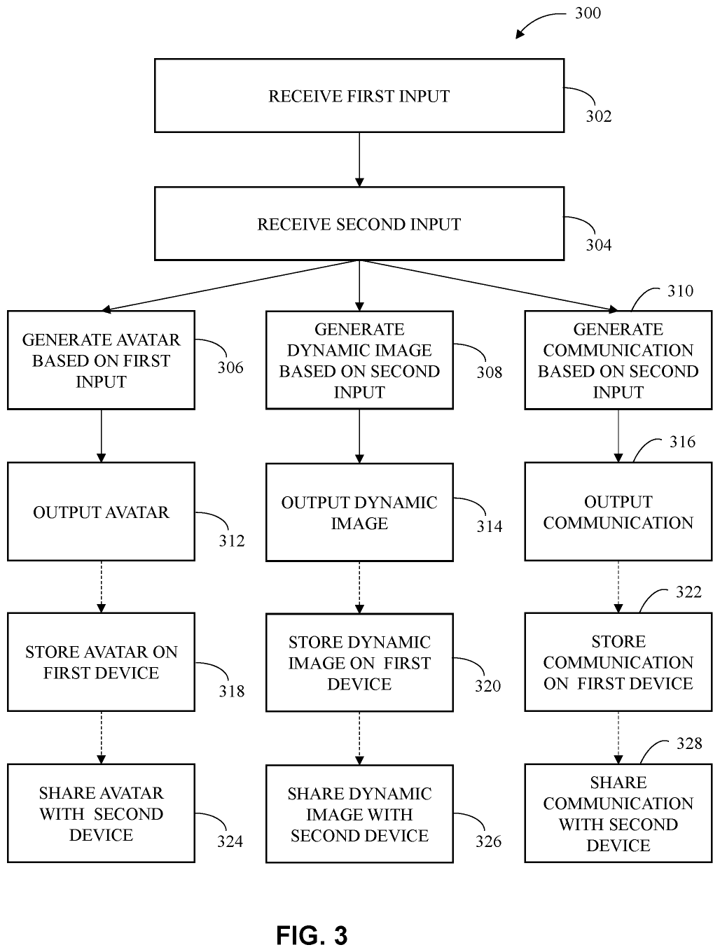

FIG. 3 illustrates an example method 300 of system 100. The method 300 includes generating, outputting, storing, and sharing multisensory semiotic communications. At step 302, the system 100 receives a first input. The first input may be an image, a typed phrase, a spoken phrase, a selection input or any input that may be used to generate an avatar or any other desirable feature. After system 100 receives a first input, the method 300 continues to step 304. At step 304, the system 100 receives a second input. The second input may be a typed phrase, a spoken phrase, a selection input, or any input that may be used to generate a dynamic image or a communication, or any other desirable feature. Upon receiving the second input, the system 100 continues to steps 306, 308, and 310. The system 100 may proceed to any of the steps 306, 308, and 310 simultaneously or at separate times.

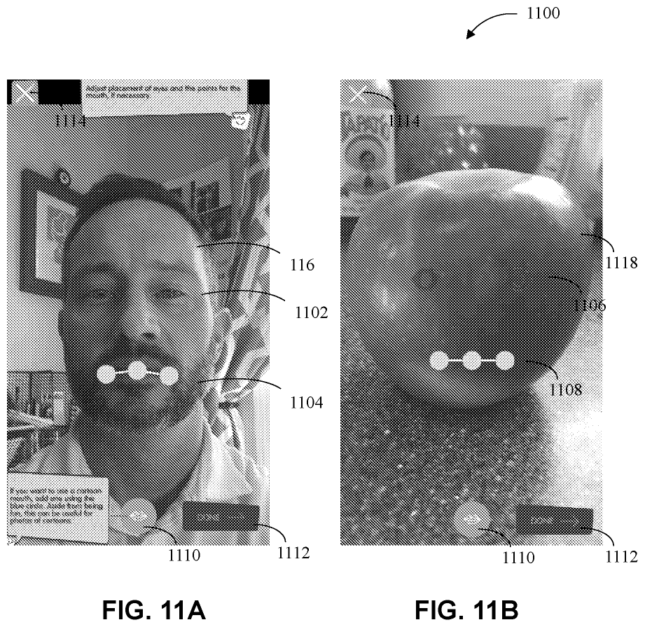

At step 306, an avatar such as avatar 204 can be generated based on the first input. The avatar may be generated from any animate or inanimate object. For example, the avatar may be generated from an image of a person as seen in FIG. 2. The avatar 204 may have one or more facial features such as eyes 210, a mouth 216, a nose 214, and ears 212. The avatar may have a full body or just a neck and head. If the first input is an image then the avatar may be selected from an object within the image. For example, the first input may be an image of an apple 1118, therefore, the generated avatar would be an apple 1118 similar to the apple 1118 within FIG. 11B. If the first input is a typed phrase or a spoken phrase then step 306 may comprise selecting an image based on the typed phrase or spoken phrase and then generating the avatar based on the typed phrase or spoken phrase. For example, a user may type the word “apple” or may record the word “apple,” then an image of an apple can be selected, which can then be used to generate the avatar. A typed or spoken phrase may also be used to display relevant images for the user to select. Once the system 100 receives a selected image then that image will be used to generate an avatar. The first input may also be a selection input. A list of user-generated images or system-generated images may be presented and a selection input may correspond to one of the images. When the selection input is received, one of the images can be selected, and then the image can be used to generate the avatar.

At step 308, a dynamic image can be generated based on the second input. A dynamic image may be any moving image that is associated with or based on the second input. If the received second input is a typed phrase then the typed phrase can be analyzed and then the dynamic image can be generated from the typed phrase. If the received second input is a spoken phrase, then the spoken phrase can be converted into a typed phrase, analyzed and then the dynamic image can be generated from the typed phrase. For example, the typed phrase can be sent to a search box or a look-up table and one or more images can be presented to the user to select which images the dynamic image should be generated from. The second input may also be a selection input. A list of user-generated images or system-generated images may be presented and a selection input may correspond to one of the images. When the selection input is received, one of the images can be selected, and the dynamic image can be generated based on one of the images.

At step 310, a communication can be generated based on the second input. The communication may be verbal phrase spoken by the avatar, a typed phrase displayed near the avatar, or sign language generated by the avatar. If the received second input is a typed phrase then the typed phrase may be used, converted into speech, or converted into sign language. If the received second input is a spoken phrase then the spoken phrase may be used, converted into a typed phrase, or converted into sign language. The second input may also be a selection input. A list of images or words may be presented and one or more selection inputs may correspond to one or more of the images or words which, when combined, generate the communication. An example of generating a communication using a selection input is shown in FIGS. 13A-D. Steps 306, 308, and 310 may be completed at the same time such as simultaneously with one another. The steps may also be completed separately from one another such as by performing step 306 before step 308 and before step 310. When these steps are completed, step 306 continues to 312, step 308 continues to 314, and step 310 continues to step 316.

At steps 312, 314, and 316, the avatar, the dynamic image, and the communication can be output to the display 110. An animation area may be created on the display 110 to set where the avatar, dynamic image, and communication are displayed. The avatar, dynamic image, and communication may be selected and placed in any location on the display 110. The avatar may be displayed at the center of the display 110 and the dynamic image and communication may be displayed under the avatar. More than one avatar, dynamic image, and communication may be output to the display 110. The communication may be output in the form of a typed phrase on the display 110, a spoken phrase to be spoken by the avatar, or sign language to be signed by the avatar. All three forms of the communication may be output at the same time. The combination of the avatar, dynamic image, and communication create the multisensory semiotic communications that is desired from the method. Steps 312, 314, and 316 may be completed at the same time such as simultaneously with one another. The steps may also be completed separately from one another such as by performing step 312 before step 314 and before step 316. When these steps are completed, step 312 continues to 318, step 314 continues to 320, and step 316 continues to step 322.

At steps 318, 320, and 322, the avatar, dynamic image, and communication can be stored to the memory 106 of a first device. Each may be saved separately or with one another. At steps 324, 326, and 328, the avatar, dynamic image, and communication may be shared with a second device. Each may be shared separately or with one another. The avatar, dynamic image, and communication may be shared with a second device without first being saved to the first device. The method 300 may end after storing the multisensory semiotic communications to the first device or after sharing the multisensory semiotic communications with the second device.

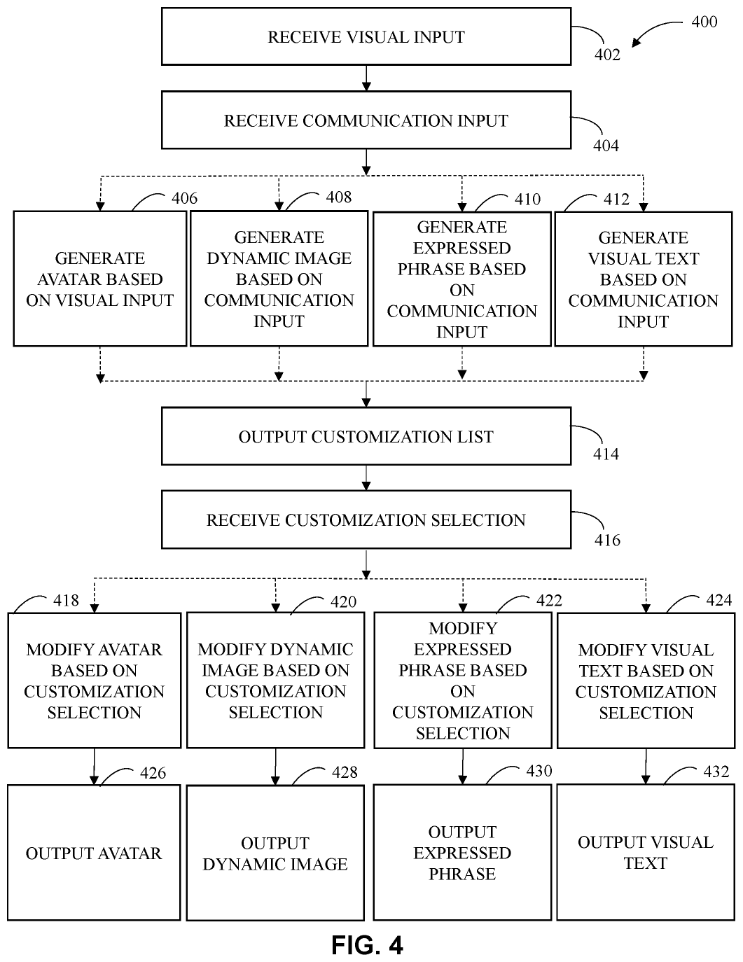

FIG. 4 illustrates an example method 400 of generating, modifying, and outputting multisensory semiotic communications. Method 400 begins at step 402 where a visual input can be received. The visual input can be similar to the first input received in FIG. 3, therefore, the visual input may be an image, a typed phrase, a spoken phrase, a selection input, or any input that may be used to generate an avatar. After receiving the visual input, the method 400 continues to step 404. Step 404 can comprise receiving a communication input. The communication input can be similar to the second input received in FIG. 3. For example, the communication input can be a typed phrase, a spoken phrase, a selection input, or any input that to generate a dynamic image, an expressed phrase, or a visual text. Upon receiving the communication input, method 400 continues to steps 406, 408, 410, and 412. Steps 406, 408, 410, and 412 can be optional steps. After steps 406, 408, 410, and 412 are completed, the system 100 proceeds to step 414. If system 100 does not proceed to steps 406, 408, 410, and 412, then system 100 can proceed directly to step 414.

At step 406, an avatar such as avatar 204 can be generated based on the visual input. The avatar may be generated from any animate or inanimate object. For example, the avatar may be generated from an image of a person as seen in FIG. 2. The avatar may have one or more facial features such as eyes, a mouth, a nose, and ears. The avatar may have a full body or just a neck and head. If the visual input is an image then the avatar may be selected from an object within the image. For example, the visual input may be an image of an apple, therefore, the generated avatar would be an apple similar to the apple within the image. If the visual input is a typed phrase or a spoken phrase then step 406 may comprise selecting an image based on the typed phrase or spoken phrase and then generating the avatar based on the typed phrase or spoken phrase. For example, a user may type the word apple or may record the word apple, then an image of an apple can be selected, which can then be used to generate the avatar. A typed or spoken phrase may also be used to display relevant images for the user to select from. Once an image is selected then that image will be used to generate an avatar. The visual input may be a selection input as well. A list of user-generated images or system-generated images may be presented and a selection input may correspond to one of the images. When the selection input is received, one of the images can be selected, and then the image can be used to generate the avatar.

At step 408, a dynamic image such as dynamic image 242 and 248 can be generated based on the communication input. A dynamic image may be any image that can be associated with or based on the communication input. If the received communication input is a typed phrase then the typed phrase can be analyzed and then the dynamic image can be generated from the typed phrase. If the received communication input is a spoken phrase, then the spoken phrase can be converted into a typed phrase, analyzed and then the dynamic image can be generated from the typed phrase. For example, the typed phrase can be sent to a search box or a look-up table and one or more images can be presented to the user to select which images the dynamic image should be generated from. The communication input may also be a selection input. A list of user-generated images or system-generated images may be presented and a selection input may correspond to one of the images. When the selection input is received, one of the images can be selected, and the dynamic image can be generated based on one of the images.

At step 410 and 412, an expressed phrase and a visual text such as visual text 244 and 250 can be generated based on the communication input. The communication generated in FIG. 3 can be similar to the expressed phrase and the visual text. The expressed phrase may be any form of communication that can be spoken or expressed through body language or other means. Therefore, the expressed phrase can comprise a verbal phrase spoken by the avatar and sign language generated by the avatar. If the received communication input is a spoken phrase then the spoken phrase may be used or converted into sign language to generate the visual input. If the received communication input is a typed phrase then the typed phrase may be converted into speech or converted into sign language in order to generate the expressed phrase.

The visual text may be any form of communication that can be written out such as a typed phrase. If the received communication input is a typed phrase then the typed phrase may be used to generate the visual input. If the received communication input is a spoken phrase then the spoken phrase may be converted into a typed phrase to generate the visual text. The communication input may also be a selection input. A list of images or words may be presented and one or more selection inputs may correspond to one or more of the images or which, when combined, generate the expressed phrase and/or the visual text. An example of generating the expressed phrase and the visual text using a selection input is shown in FIGS. 13A-D.

The expressed phrase and visual text may also be generated using artificial intelligence (AI) technology. The AI technology may generate the expressed phrase and visual text in a multitude of ways. In one embodiment, an image is loaded to the system which is then analyzed by the AI technology. The image may be loaded to the system by using a camera feature on the system to take a picture, by using a picture from the saved pictures on the system, or by downloading a picture from an online database. The analysis conducted by the AI technology generates an expressed phrase and/or visual text based on the image. Thus, a user can load digital images from his or her camera into the cloud-based AI program, and have the animated avatars say the words that the AI program associates with the images. As an example, if the image is a picture of a forest then the AI technology will generate a number of expressed phrases and visual texts such as “forest,” “trees,” and “woods.” The expressed phrases and visual texts may also be complete sentences such as “I see a forest,” “we see the woods,” and “that is a tree.” Any response may be selected for the expressed phrase and visual text. The expressed phrases and visual texts are not limited to these examples. This AI technology, which pairs visual images with written text, allows users to take photos of objects in their direct environment and learn to say the words associated with those objects in real time.

In another embodiment, a phrase or text is loaded to the system which is then analyzed by the AI technology. The phrase or text may be loaded to the system by using a microphone feature on the system, by using a phrase or text within a note or another application saved on the system, or by downloading a phrase or text from an online database. The analysis conducted by the AI technology generates an expressed phrase and/or visual text based on the phrase or text. The expressed phrases and visual texts are generated using a predictive engine on the system, therefore, the AI technology analyzes the inputted phrase or text and generates an expressed phrase or visual text that may be associated with the inputted phrase or text. The AI technology may use past data such as previous desired responses or by using data stored on an online database to best generate the responses. As an example, if the phrase “do you want something to eat?” is spoken near the microphone then the AI technology may generate a number of possible responses. Examples of the expressed phrase and/or visual text generated by the AI technology may be “yes,” “no,” or “maybe.” The expressed phrases and visual texts may also be complete sentences such as “I want something to eat,” “we do not want something to eat,” and “yes, I want pizza.” Any food may be suggested but it is possible that the user has requested pizza many times before so the AI technology analyzes this and suggest pizza based on past experiences. Any response may be selected for the expressed phrase and visual text. The expressed phrases and visual texts are not limited to these examples. Steps 406, 408, 410, and 412 may be completed at the same time or separately, and when these steps are completed, method 400 moves continues to step 414.

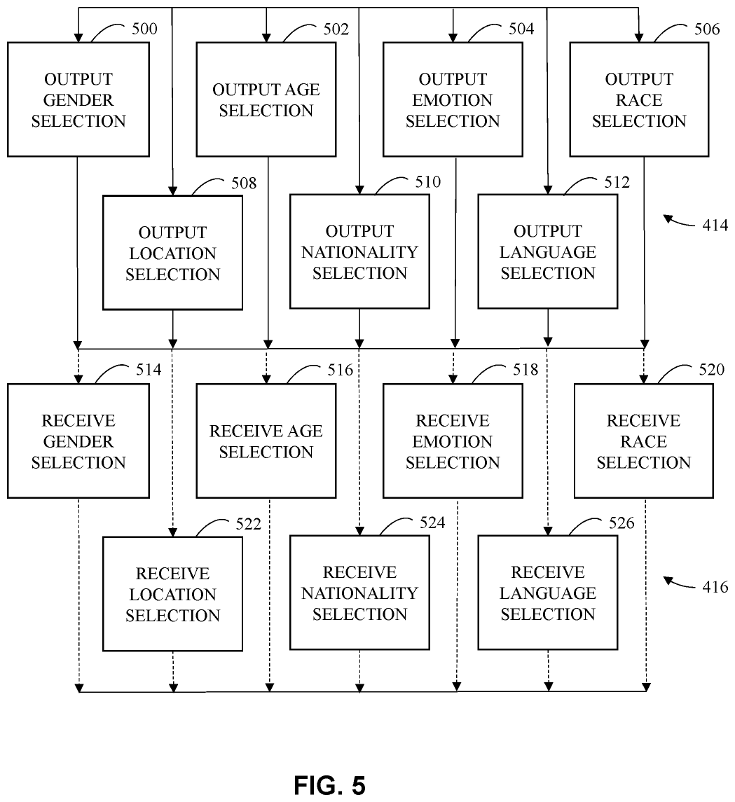

At step 414, a customization list can be output to the display 110 and at step 416, a customization selection can be received. Both of these steps are shown in FIG. 5 which is a continuation of method 400. The customization list can be a list of possible selections that may modify any of the received multisensory semiotic communications. Looking at step 414 of method 400, outputting the customization list can comprise outputting a gender selection 500, an age selection 502, an emotion selection 504, a race selection 506, a location selection 508, a nationality selection 510, and a language selection 512. The customization list is not limited to these selections and may comprise any selection used to modify the above described multisensory semiotic communications.

The received customization selection may be sent by the user or the system 100 and may indicate which selection from the customization list should be used to modify the multisensory semiotic communications. Looking at step 416 of method 400, receiving the customization selection may comprise receiving a gender selection 514, an age selection 516, an emotion selection 518, a race selection 520, a location selection 522, a nationality selection 524, and a language selection 526. The gender selection 514 may comprise either male or female, the age selection 516 may comprise any age, an emotion selection 518 may comprise any emotion such as anger, happy, sad, or any other desirable emotion, the race selection 520 may comprise Asian, American, African American, or any other desirable race, the location selection 522 may comprise any country around the world or may be more specific such as a city, the nationality selection 524 may comprise American, Polish, British, Russian, Irish, or any other desirable nationality, and the language selection 526 may comprise Chinese, Spanish, English, Hindi, Arabic, Portuguese, German, or any other desirable language. The customization selection is not limited to these selections and may comprise any selection used to modify the above described multisensory semiotic communications. All of the selections may be outputted to the display 110 and one or more may be received, as desired by the user or the system.

Moving back to FIG. 4, after step 416 ends, method 400 continues to steps 418, 420, 422, and 424. At steps 418, 420, 422, and 424, the received customization selection can be used to modify at least one of the multisensory semiotic communications. At step 418, the avatar can be modified, at step 420, the dynamic image can be modified, at step 422, the expressed phrase can be modified, and at step 424, the visual text can be modified. One or more customization selections may be used to modify the multisensory semiotic communications. Not every customization selection may be used to modify the communications.

At step 418, the one or more customizations selections modify the avatar. The gender selection 514 may modify the gender of the avatar such as by changing the avatar to a female or a male. This may be done by adding female or male characteristics to the avatar. The age selection 516 may modify the age of the avatar such as by making the avatar look younger or older. Modifying the age of the avatar may comprise adding age characteristics to the avatar such as wrinkles to appear older or other facial features. Further, the height of the avatar may be changed to appear younger or older. The emotion selection 518 may modify the avatar by changing the emotional appearance of the avatar. Emotion characteristics may be added such as by changing the body language or facial features of the avatar. The avatar may have crossed arms and a frown to appear angry, the avatar may be smiling to simulate happiness, or the avatar may have tears to show sadness. The race selection 520 may change the appearance of the avatar by adding racial characteristics. These racial characteristics may comprise changing skin tone, stature, head form, facial features, hair, body shape, and body language. The location selection may be used to modify the avatar by saving modifications based on a location. A user or the system 100 may create and save any number of avatars or characteristics to a certain location such as The United States or more specifically Napa, California. The location is not limited to this and may be any location within the world. The nationality selection 524 may modify the avatar by adding nationality characteristics. Nationality characteristics may comprise changing the appearance of the avatar through adding common features found in certain nationalities around the world. The language selection 526 may not be used to modify the avatar, but, the language selection 526 may change the language used throughout the setup screen to the selected language. The language may be any language used throughout the world such as Chinese, Spanish, English, Hindi, Arabic, Portuguese, German, or any other desirable language.

At step 420, the one or more customizations selections modify the dynamic image. The selections may change the types of dynamic images which appear for selection or make selections to the selected dynamic image. The gender selection 514 may change the person within the dynamic image. If the dynamic image is portraying “through” as shown in FIG. 2, then selecting female can allow the dynamic image to portray “through” with a female. Further, it can be possible that only certain images appear when an age selection 514 is received, such as images of dolls for females or images of cars for boys. The age selection 516 may change the age of the person within the dynamic image. If the age selection 516 is set to a young child then the dynamic image may show a young child within the dynamic image as shown in the second dynamic image in FIG. 2. Further, changing the age may change the types of images that appear, such as a young age selection will prevent images not suitable for young ages to be shown. The emotion selection 518 may change the emotion shown within the dynamic images such as by selecting a dynamic image portraying happiness when happy is selected as an emotion. The location selection 522 may change which dynamic images appear to the user or on the system 100. The user or the system 100 may first set which dynamic images should appear within a designated location and upon entering the designated location, the dynamic images can be presented to the user. The language selection 526 may change the language contained within the dynamic images or only display dynamic images with text of the selected language. The race selection 520 and nationality selection 524 may or may not modify the dynamic images.

At step 422, the one or more customizations selections modify the expressed phrase. Modifying the expressed phrase using the selections can comprise changing suprasegmentals of the expressed phrase. A suprasegmental is a feature of speech which may comprise stress, tone, word juncture, prominence, pitch or any other desirable suprasegmental. Every selection, the gender selection 514, the age selection 516, the emotion selection 518, the race selection 520, the location selection 522, the nationality selection 524, and the language selection 526 may modify the expressed phrase using the elements of suprasegmentals. The gender selection 514 may change the gender of the expressed phrase. If the user selects a female then the expressed phrase will be spoken by a female voice. The age selection 516 may change the pitch of the expressed phrase. If the user desires a child to speak the expressed phrase then increasing the pitch simulates the expressed phrase being spoken by a young child. The emotion selection 518 may change the emotion of the expressed phrase by adding the user desired emotion to the expressed phrase. If the user desires the expressed phrase to be spoken by someone happy, then the user will select the emotion happiness and the expressed phrase will be spoken to simulate happiness. The race selection 520 may change the expressed phrase to simulate the expressed phrase being spoken by someone of the desired race. The location selection 522 may further adjust suprasegmentals of the expressed phrase by linking certain dialects of speech to the location selection. The nationality selection 524 may adjust the suprasegmentals of the expressed phrase by modifying the expressed to simulate different nationalities throughout the world. The language selection 526 may modify the expressed phrase by changing the language of the expressed phrase. Any language may be selected such as Chinese, Spanish, English, Hindi, Arabic, Portuguese, German, or any other desirable language.

At step 424, the one or more customizations selections can modify the visual text. Not every selection may modify the visual text. The language selection 526 may modify the language of the visual text. Any language may be selected, such as Chinese, Spanish, English, Hindi, Arabic, Portuguese, German, or any other desirable language.

At steps 426, 428, 430, and 432, the avatar, the dynamic image, the expressed phrase, and the visual text, respectively, can be output to the display 110. An animation area may be created on the display 110 to configure where the avatar, dynamic image, expressed phrase, and visual text are displayed. The avatar, dynamic image, expressed phrase, and visual text may also be selected and placed in different locations on the display 110. The avatar may be displayed at the center of the display 110, and the dynamic image and visual text may be displayed under the avatar. More than one avatar, dynamic image, expressed phrase, and visual text may be output to the display 110. The visual text may be output in the form of a typed phrase on the display 110 and the expressed phrase may be output in the form of a spoken phrase to be spoken by the avatar or sign language to be signed by the avatar. All three forms of the communication may be output at the same time. The combination of the avatar, dynamic image, expressed phrase, and visual text create the multisensory semiotic communications that can be desired from the method. Steps 426, 428, 430, and 432 may all be completed at the same time or separately, and when all steps are completed, method 400 ends.

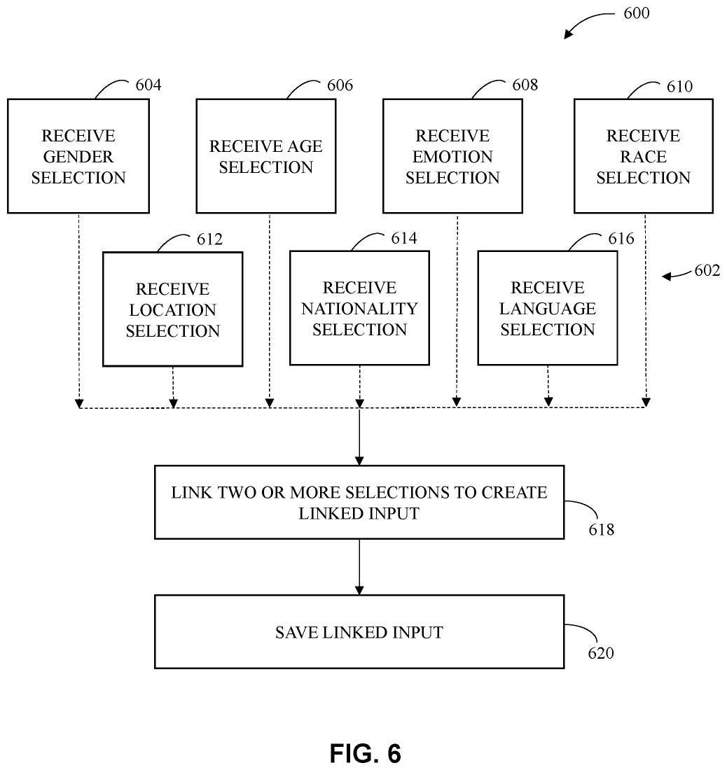

FIG. 6 illustrates an example method 600 of receiving at least two customization selections, linking the two or more selections together to create a linked input, and saving the linked input. At step 602, a customization selection can be received. The customization selection may comprise receiving a gender selection 604, an age selection 606, an emotion selection 608, a race selection 610, a location selection 612, a nationality selection 614, and a language selection 616. The selections may comprise any of the above listed classifications within FIG. 4. The customization selection is not limited to these selections and may comprise any selection that may be used as a unique identifier. All of the selections may be outputted to the display 110 or one or more selections may be received, as desired by the user or the system 100.

Upon receiving two or more selections, method 600 moves continues to step 618. At step 618, the two or more selections can be linked together to create a linked input. The selections may be linked together in order for a second selection to be used to modify any of the multisensory semiotic communications upon receiving a first selection. Any of the two or more selections may be linked together. Linking the two or more selections together can allow the user or the system 100 modify the emotion, nationality, language, and race of any of the multisensory semiotic communications when receiving a location selection. If the emotion selection, nationality selection, language selection, and the race selection can be linked to the location selection then any of the multisensory semiotic communications will be modified when a user or the system 100 enters the defined location. The user or the system 100 can set the emotion, nationality, language, and race to a specific location such as The United States, or more specifically, Napa, California. The location is not limited to this and may be any location around the world. When step 618 ends, method 600 continues to step 620.

At step 620, the linked inputs can be saved to the memory 106 on the device. Saving the linked inputs to the device can allow the user or the system 100 to refer back to the linked input at any given time. When step 620 ends, method 600 ends.

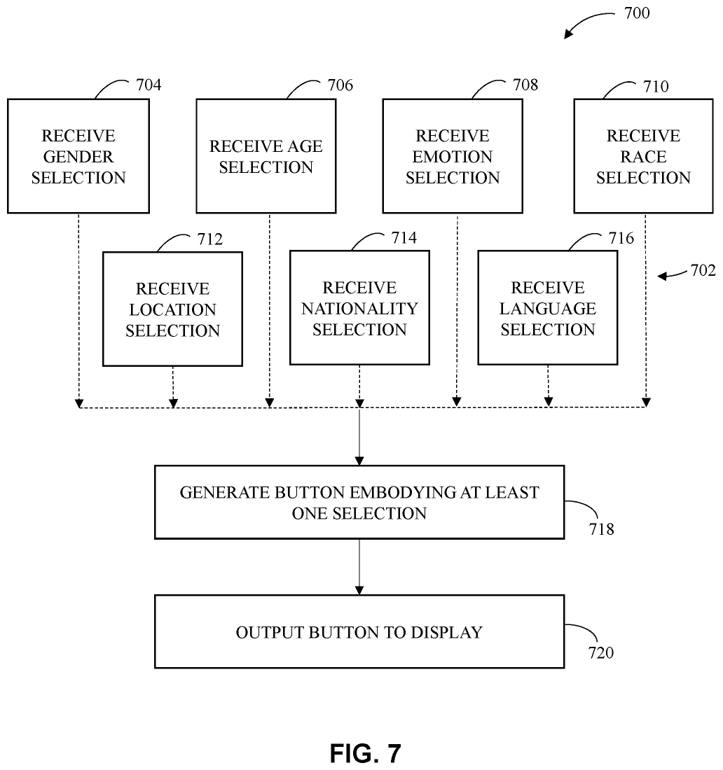

FIG. 7 illustrates an example method 700 of receiving a customization selection, generating a button based on the customization selection, and outputting the button to a display 110. At step 702, a customization selection can be received. The customization selection may comprise receiving a gender selection 704, an age selection 706, an emotion selection 708, a race selection 710, a location selection 712, a nationality selection 714, and a language selection 716. The selections may comprise any of the above listed classifications within FIG. 4. The customization selection is not limited to these selections and may comprise any selection that may be used as a unique identifier. All of the selections may be outputted to the display 110 or one or more may be received, as desired by the user or the system 100. When step 702 ends, method 700 continues to step 718.

At step 718, a button can be generated based on at least one selection. These buttons, after being generated, and output to the display 110, allow the user to activate the selection by clicking on the button. When the selection is activated by clicking on the button, the multisensory semiotic communications can be modified as desired by the selections embodied in the button. For the gender selection 704, two gender buttons may be created, one for a female and one for a male. For the age selection 706, multiple age buttons may be created embodying varying ages. One button could be an image of a child, and another button could be an image of an adult. Other images for these buttons may be used such as a button containing a scroll wheel which can allow the user to modify the multisensory semiotic communications with age by moving the scroll wheel from a young age to an older age. For the emotion selection 708, multiple emotion buttons may be created embodying varying emotions. These emotion buttons may comprise different images of children, adults, or emoticons showing different emotions such as anger, happy, sad, or any other desirable emotion. For the race selection 710, multiple race buttons may be created embodying varying races. These race buttons may comprise different images of children, adults, or other images embodying different races. These races may comprise Asian, American, African American, or any other desirable race. For the location selection 712, multiple location buttons may be created embodying varying locations. These location buttons may comprise different images of flags, countries, capitol buildings, or other images embodying different locations around the world. For the nationality selection 714, multiple nationality buttons may be created embodying varying nationalities. These nationality buttons may comprise different images of children, adults, or other images embodying different nationalities. These nationalities may comprise American, Polish, British, Russian, Irish, or any other desirable nationality. For the language selection 714, multiple language buttons may be created embodying varying languages. These language buttons may comprise different images of words in varying languages, languages, or other images embodying different languages. These languages may comprise Chinese, Spanish, English, Hindi, Arabic, Portuguese, German, or any other desirable language.

At step 720, the button can be output to the display 110. An animation area may be created on the display 110 to set where the button is displayed. More than one button may be output to the display 110 at one time; therefore, every gender button, age button, emotion button, race button, location button, nationality button, and language button may be output to the display 110. Once the buttons are displayed, activating any of the buttons will modify the multisensory semiotic communications corresponding to the button embodying the selection. Activating the gender buttons will modify the gender of the multisensory semiotic communications as described above. Activating the age buttons will modify the age of the multisensory semiotic communications as described above. Activating the emotion buttons will modify the emotion of the multisensory semiotic communications as described above. Activating the race buttons will modify the race of the multisensory semiotic communications as described above. Activating the location buttons will modify the multisensory semiotic communications based on location as described above. Activating the nationality buttons will modify the nationality of the multisensory semiotic communications as described above. Activating the language buttons will modify the language of the multisensory semiotic communications as described above. When step 720 ends, method 700 ends.

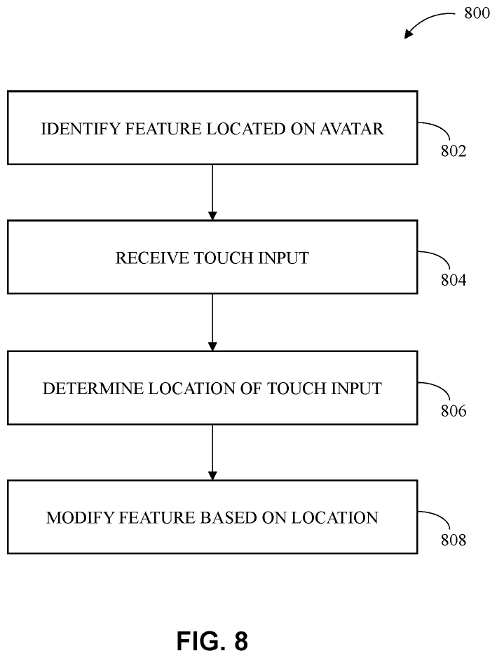

FIG. 8 illustrates an example method 800 of modifying a feature on an avatar upon receiving a touch input. Method 800 starts with step 802. At step 802, a feature can be identified on the avatar. This feature may be a facial feature or any feature located on the avatar such as on the avatar's body or face. When one or more features are identified, step 802 ends and method 800 continues to step 804.

At step 804, a touch input can be received. The touch input may be received anywhere on the display 110. The touch input may be received on the feature identified in step 802 or anywhere around the feature. When the touch input is received, step 804 ends, and method 800 continues to step 806.

At step 806, the location of the touch input is determined. The device determines the touch location similarly to how any touch screen device determines the location of a user touching the screen of the device. The device may also have a camera which may be used to determine the location of the touch input. When the location of the touch input is determined, step 806 ends, and method 800 continues to step 808.

At step 808, the feature identified in step 802 can be modified based on the location of the touch input. If the identified feature in step 802 were one or more eyes of the avatar then the eyes may be modified to move in order to simulate looking at the location of the touch input as determined in step 806.

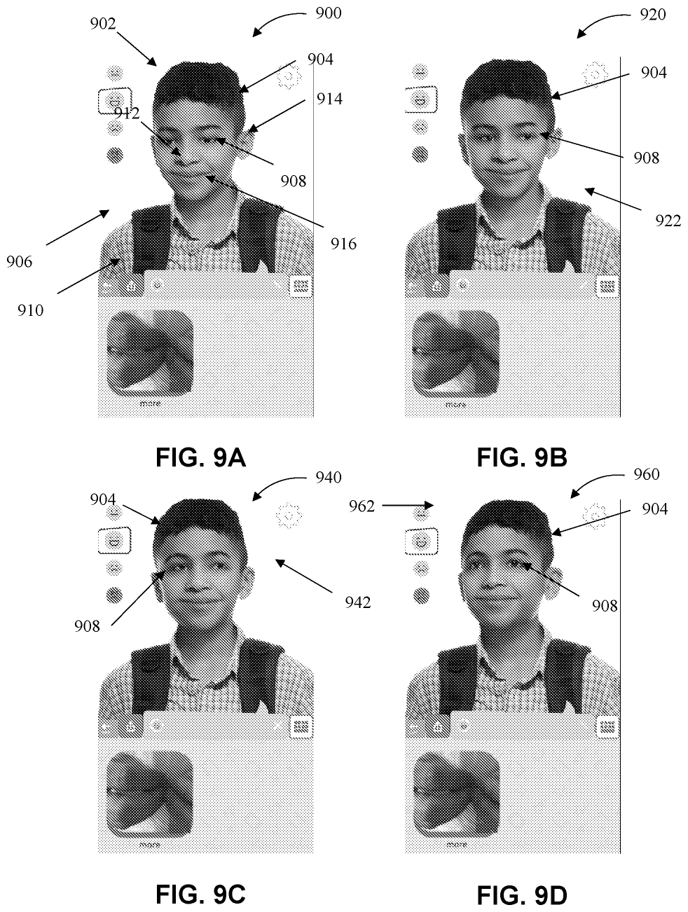

FIGS. 9A-D illustrate an example method of identifying a feature on an avatar and modifying the feature based on a touch location as described in FIG. 8. FIGS. 9A-D can show four different views 900, 920, 940, 960 of an avatar 902 having a head 904 with eyes 908 and four touch inputs 906, 922, 942, 962. The avatar 902 also has a head 904 and a body 910. The head 904 also has a nose 912, ears 914, and a mouth 916. In other embodiments additional features may be identified such as the nose 912, the ears 914, and the mouth 916. The identified feature may also be the body 910. The difference between the views is the location of the many touch inputs. Further, in all of these views, the modification desired was moving the identified features, the head 904 and the eyes 908. In FIG. 9A the first touch input 906 was received and determined to be located in the bottom left quadrant of the view. The head 904 and the eyes 908 were modified to move towards the first touch input 906. In FIG. 9B the second touch input 922 was received and determined to be located in the bottom right quadrant of the view. The head 904 and the eyes 908 were modified to move towards the second touch input 906. In FIG. 9C the third touch input 942 was received and determined to be located in the top right quadrant of the view. The head 904 and the eyes 908 were modified to move towards the third touch input 942. In FIG. 9D the fourth touch input 962 was received and determined to be located in the top left quadrant of the view. The head 904 and the eyes 908 were modified to move towards the fourth touch input 906. This is merely one illustration of method 800, therefore, many other features may be identified and other touch inputs may be received.

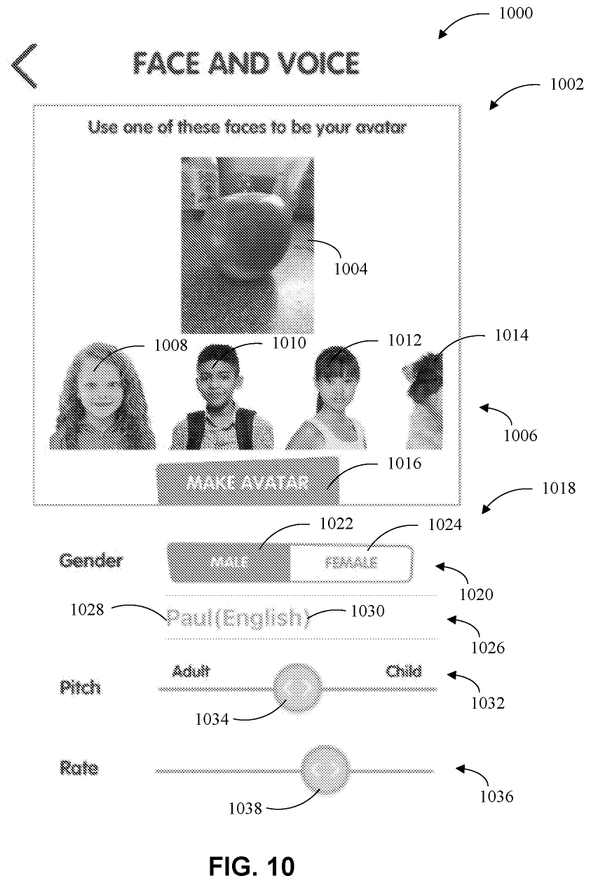

FIG. 10 illustrates an example setup of the multisensory semiotic communications layout on the display 110 where setup screen 1000 can comprise an avatar selection screen 1002, and a customization selection screen 1018. The avatar selection screen 1002 can comprise a user-generated image 1004 as well as a system-generated image 1006. The user may take a picture which can then be uploaded to the device to appear as the user-generated image 1002. In this embodiment, a user photographed an apple in order to use the apple as an avatar. The user may take a photo of any object or may select any image from their device. The system-generated images 1006 can be generated avatars that may be selected and used with current method. Any number of avatars may appear in section 1006, and these system-generated avatars 1006 may be updated regularly to include more avatars. The system-generated images 1006 includes an image of a young girl 1008, an image of a young boy 1010, and image of an adolescent girl 1012, and an image of a dog 1014. The current avatars are shown to be animate objects, but the avatars are not limited to animate objects and any inanimate object may be used as well. The avatar selection screen 1002 illustrates the first step in generating an avatar: selecting the image to use as a base. The avatar selection screen 1002 contains a “make avatar” button 1016 which will generate the avatar once the desired image is selected. Once the image is selected, whether a user-generated avatar 1004 or a system-generated avatar 1006, the avatar generation continues in FIGS. 11A and B.

The customization selection screen 1018 as shown at the bottom of the setup screen 1000 may comprise any number of customization selections. The current customization selection screen 1018 contains a gender selection 1020, a name and language selection 1026, and suprasegmental selections 1032, 1036. The gender selection 1020 can comprise a selection of male 1022 or female 1024 and may be displayed as shown on the setup screen 1000 or may be displayed in any other way possible. Next, the name and language selection 1026, can allow the user to name the generated avatar as well as set the language of the expressed phrase and visual text. This name may then appear on the display 110 after an avatar is generated or the generated avatar may be saved under the selected name. Selecting a language translates every spoken or typed phrase to the selected language, therefore, a user may input a phrase in English, select French as the intended language, and the phrase will be translated to French. Further, if the user types a phrase in English, but selects French as their language, then the typed phrase will be adjusted to a spoken phrase, and both phrases will be translated to French before being outputted to the display 110. Here, the name is shown to be Paul 1028 and English 1030 has been selected for the language. The first suprasegmental selection 1032 can be an age selection 1032 that can allow the user to set an age of the avatar thereby changing the voice spoken by the avatar by changing the pitch of the voice. The pitch and the age changes by adjusting the scroll wheel 1034. The pitch of the spoken phrase can be increased if the scroll wheel 1034 is moved to the right, thereby lowering the age of the avatar, and the pitch can be lowered if the scroll wheel is moved to the left, thereby increasing the age of the avatar. The second suprasegmental selection 1036 can be a speed selection 1036 which can allow the user to change the speed in which an expressed phrase is spoken by the avatar. The speed selection 1036 also has a scroll wheel 1038 that can allow the speed to be adjusted. The rate in which the avatar speaks can be slowed if the scroll wheel 1038 is moved to the left and the rate can be increased if the scroll wheel 1038 is moved to the right. The setup screen 1000 only illustrates a few selections and instead may comprise any number of customization selections. Notably, the setup screen 1000 may not only comprise a gender selection, an age selection, and a suprasegmental selection, but may also comprise an emotion selection, a race selection, a location selection, a nationality selection, and a language selection.

An emotion selection may comprise changing the emotional expression of the avatar or changing the emotional output of the expressed phrase. Changing the emotional expression of the avatar may comprise changing the facial expressions or body expressions of the avatar. Changing the emotional output of the expressed phrase may be done by adjusting the suprasegmentals of the phrase. The suprasegmentals may comprise changing a pitch, a tone, a word stress, a phonation, a resonance, a fluency, an intonation, a voice, or a speed of the expressed phrase. A race selection, nationality selection, and language selection may adjust the appearance of the avatar or may further adjust the suprasegmentals of the expressed phrase. A location selection may also modify the avatar or the expressed phrase, but may also adjust the dynamic image. Setting a location may allow the dynamic image to be pulled from a database relevant to the location set. The changes made by the customization selections may be added by a user or may be pre-loaded within the system 100. Further selections or changes to previously added selections may be added regularly on system updates.

FIGS. 11A and B illustrate an example layout on a device illustrating the setup of the multisensory semiotic communications. FIGS. 11A and B continue the avatar generation as discussed within FIG. 10. Setup screen 1100 illustrates two different layouts of avatar generation where the system 100 or the user selects the facial features on the avatar. FIG. 11A illustrates an animate object where the system 100 locates the eyes 1102 and the mouth 1104 of the avatar. The animate object is a human male 1116. FIG. 11B illustrates an inanimate object where the system 100 places eye animators 1106 or a mouth animator 1108 on the inanimate object. The inanimate object is an apple 1118. The user may adjust the animators 1106, 1108 in any way such as by moving the animators 1106, 1108 to a different location, adjusting the size of the animators 1106, 1108, or by rotating the animators 1106, 1108. The facial features may be generated with the facial feature generation button 1110 which can allow the user to select any number of features to be placed on the avatar. The facial features are not limited to eyes and a mouth, and may comprise ears, a nose, or any other desirable facial feature. The avatars are not limited to the human male 1116 and apple 1118 shown in FIGS. 11A and B and any avatar may be selected for the process of adding facial features. A complete button 1112 and exit button 1114 are also shown in FIGS. 11A and B. The complete button 1112 can allow the user to finish the avatar creation process which then outputs the generated avatar to the display 110. The exit button 1114 can allow the user to exit out of the setup screen 1100 in order to restart the avatar creation process.

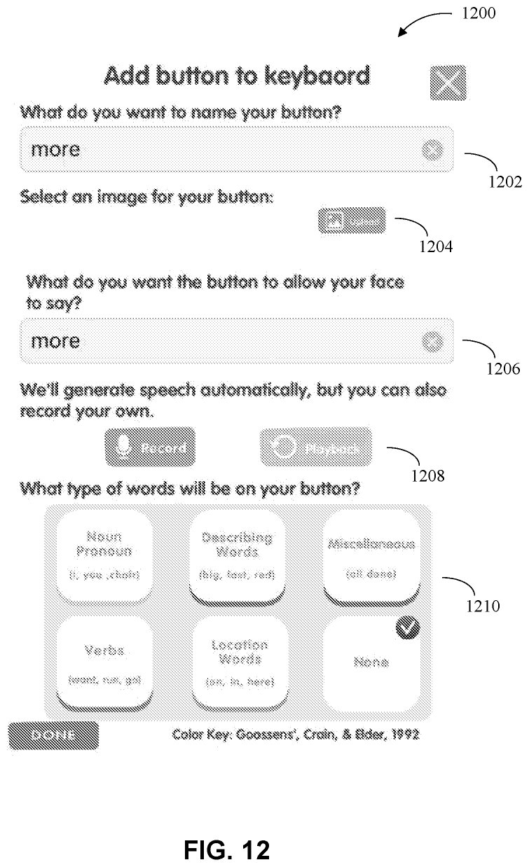

FIG. 12 illustrates an example setup of the multisensory semiotic communications layout on the display 110. Setup screen 1200 illustrates one way of creating a button. A button is a clickable icon located on the display 110 which modifies the avatar, dynamic image, expressed phrase, or visual text in any way possible. The button creation process may start at the naming process 1202 as shown on setup screen 1200. During the naming process 1202, a user may call the button whatever they want. This name may appear superimposed on the button, around the button, or not at all. The next step on the setup screen 1200 is the image selection process 1204. During the image selection process 1204, the user may select any image for their button. The user may select an image from their device or an image from a repository on the internet. Next the process continues to selecting what the button will do. As shown, a user may enter a typed phrase 1206 or a spoken phrase 1208. Depending on the phrase entered, the application may use a text-to-speech engine or a speech-to-text engine. Lastly, the user may selection a customization feature 1210 for the button. The customization feature 1210 shown can allow the user to select a type of word to place on the button, but is not required to do so.

The setup screen 1200 illustrates one way of creating a button. In one embodiment, a customization list may be outputted to the display 110 which can comprise at least one of a gender selection, an age selection, an emotion selection, a race selection, a location selection, a nationality selection, and a language selection. A customization selection based on at least one of the selections from the customization list may be received. The process continues by generating a button embodying the customization selection and outputting the button to the display 110. The button may have any number of customization selections or more than one button may be created embodying multiple customization selections. The buttons may be created by the user or may already be saved to the display 110 for the user to select. A button selection based on the generated button may be received which activates the button, thereby activating the customization selection. The customization selection then modifies at least one of the avatar, dynamic image, expressed phrase, or visual text. Any modification may take place as discussed above.

FIGS. 13A-D illustrate an example setup of the multisensory semiotic communications which illustrates the setup of the visual text and the expressed phrase as described above. The visual text and expressed phrase generation screen may be accessed by clicking the reset button 238, or by selecting the multisensory semiotic communications selection button 240. By selecting either of these buttons, the visual text and expressed phrase generation screen appears and begins at the first stage 1300 of selecting a pronoun in FIG. 13A. The pronoun may be selected from any of the images provided in FIG. 13A or may be typed by the user. The pronoun selected was “I” as shown by image 1302. This creates a visual text of “I” shown next to the reset button 238. FIG. 13 moves to FIG. 13B where the second stage 1320 is to select a verb for the visual text and expressed phrase. The verb may be selected from any of the images provided in FIG. 13B or may be typed by the user. The verb selected was “want” as shown by image 1322. This creates a visual text of “I want” shown next to the reset button 238. FIG. 13B moves to FIG. 13C where the third stage 1340 is to create an object of the sentence. The object may be selected from any of the images provided in FIG. 13C or may be typed by the user. The object selected was “Pizza” as shown by image 1342. FIG. 13D illustrates the visual text 1362 generated from all of these stages which is “I want a slice of pizza” and shown in the final stage 1360. Any phrase may be generated using these steps, the user may type his/her own phrase at any point, or the phrase may be generated in another way.

What is claimed is:

1. A system for an interactive tool, comprising:
a non-transitory computer readable medium to store instructions of the system;
a display to provide a result of the instructions; and
a processor configured to execute the instructions, the processor being configured to:
receive a first input and a second input;
generate an avatar based on the first input; and
generate a dynamic image based on the second input.

2. The system of claim 1, wherein the avatar includes:
a form, wherein the form includes at least one of a two-dimensional form, a three-dimensional form, a complete form, and a partial form; and
a view, wherein the view includes at least one of a front view and a side view.

3. The system of claim 1, wherein the display is at least one of a mobile phone, a computer, an augmented reality device, a virtual reality device, and a device capable of creating a holographic display.

4. The system of claim 1, wherein the processor is further configured to:
generate an expressed phrase based on the second input; and
generate a visual text based on the second input.

5. The system of claim 4, wherein the expressed phrase and visual text are generated by artificial intelligence (AI) technology using a predictive speech engine.

6. The system of claim 4, wherein the processor is further configured to:
output a customization selection list to the display, wherein the customization selection list comprises at least one of a gender selection, an age selection, an emotion selection, a race selection, a location selection, a nationality selection, and a language selection;
receive a customization selection based on the customization list;
modify the avatar based on the customization selection to create a modified avatar, wherein the modified avatar comprises non-verbal communication elements;
modify the expressed phrase based on the customization selection to create a modified expressed phrase, wherein the modified expressed phrase comprises symbolic communication elements;
modify the dynamic image based on the customization selection to create a modified dynamic image, wherein the modified dynamic image comprises modifications to a dynamic animation; and
modify the visual text based on the customization selection to create a modified visual text.

7. The system of claim 6, wherein the processor is further configured to:
output at least one of the avatar and the modified avatar;
output at least one of the expressed phrase and the modified expressed phrase;
output at least one of the dynamic image and the modified dynamic image; and
output at least one of the visual text and the modified visual text.

8. The system of claim 1, wherein the processor is further configured to:
generate an emoticon embodying an emotion;
output the emoticon to the display;
receive an emoticon selection based on the emoticon; and
modify the avatar comprising the emotion based on the emoticon selection to create a modified avatar, wherein the modified avatar comprises non-verbal communication elements.

9. The system of claim 1, wherein the processor is further configured to:
identify a feature located on the avatar;
receive a touch input;
determine a location of the touch input; and
modify the feature based on the location.

10. A computer-implemented method for an interactive tool performed by a processor, comprising:
receiving a visual input and a communication input;
generating an avatar based on the visual input, wherein the avatar provides a communication based on the communication input; and
generating a dynamic image based on the communication input.

11. The computer-implemented method of claim 10, further comprising:
modifying the communication using suprasegmentals, wherein the suprasegmentals includes at least one of a pitch, a tone, a word stress, a phonation, a resonance, a fluency, a intonation, a voice, and a speed.

12. The computer-implemented method of claim 10, further comprising:
receiving a customization selection, wherein the customization selection comprises at least one of a gender selection, an age selection, an emotion selection, a race selection, a location selection, a nationality selection, and a language selection;
generating a button embodying the customization selection;
outputting the button to the display;
receiving a button selection based on the button;
modifying the avatar based on the button selection to create a modified avatar, wherein the modified avatar comprises non-verbal communication elements;
modifying the communication based on the button selection to create a modified communication, wherein the modified communication comprises symbolic communication elements; and
modifying the dynamic image based on the button selection to create a modified dynamic image, wherein the modified dynamic image comprises modifications to a dynamic animation.

13. The computer-implemented method of claim 10, further comprising:
receiving a customization selection, wherein the customization selection comprises at least one of a gender selection, an age selection, an emotion selection, a race selection, a location selection, a nationality selection, and a language selection;
modifying the avatar based on the customization selection to create a modified avatar, wherein the modified avatar comprises non-verbal communication elements;
modifying the communication based on the customization selection to create a modified communication, wherein the modified communication comprises symbolic communication elements; and
modifying the dynamic image based on the customization selection to create a modified dynamic image, wherein the modified dynamic image comprises modifications to a dynamic animation.

14. The computer-implemented method of claim 13, further comprising:
outputting at least one of the avatar and modified avatar;
outputting at least one of the communication and modified communication; and
outputting at least one of the dynamic image and the modified dynamic image;
wherein at least one of the avatar and modified avatar, at least one of the communication and modified communication, and at least one of the dynamic image and the modified dynamic image are outputted simultaneously.

15. The computer-implemented method of claim 13, further comprising:
generating a shareable file, wherein the shareable file comprises:
at least one of the avatar and modified avatar;
at least one of the communication and modified communication; and
at least one of the dynamic image and the modified dynamic image.

16. The computer-implemented method of claim 10, further comprising:
receiving a geographic location input;
receiving an emotion input;
linking the geographic location input and the emotion input to generate a linked input;
modifying the avatar based on the linked input; and
modifying the communication based on the linked input.

17. The computer-implemented method of claim 10, wherein the communication includes at least one of a spoken language, a typed language, and a sign language.

18. A system for an interactive tool, comprising:
a non-transitory computer readable medium to store instructions of the system;
a display to provide a result of the instructions; and
a processor configured to execute the instructions, the processor being configured to:
receive an image;
receive a customization selection;
generate an avatar based on at least one of the image and the customization selection;
receive a communication input;
generate a dynamic image based on at least one of the communication input and the customization selection;
generate an expressed phrase based on at least one of the communication input and the customization selection; and
generate a visual text based on at least one of the communication input and the customization selection.

19. The system of claim 18, wherein the customization selection comprises at least one of a gender selection, an age selection, an emotion selection, a race selection, a location selection, a nationality selection, and a language selection.

20. The system of claim 18, wherein the processor is further configured to:
output the avatar, wherein the avatar comprises non-verbal communication elements;
output the dynamic image, wherein the dynamic image comprises modifications to a dynamic animation.
output the expressed phrase, wherein the expressed phrase comprises symbolic communication elements; and
output the visual text.

21. The system of claim 16, wherein the processor is further configured to:
output the avatar and the dynamic image simultaneously; and
output the expressed phrase and the visual text simultaneously.
